(19) United States
(12) Patent Application Publication
(10) Pub. No.: US 2008/0271622 A1
(43) Pub. Date: Nov. 6, 2008

(54) APPARATUS AND METHOD FOR PRINTING A PRINTING SUBSTRATE WEB

(75) Inventors: Wolfgang Ronecker, Ehingen (DE); Peter Schulmeister, Pfaffenhofen (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 12/114,510

(22) Filed: May 2, 2008

(30) Foreign Application Priority Data
May 3, 2007 (DE) 10 2007 020 736.2

(51) Int. Cl. B41F 13/54

(52) U.S. Cl. 101/228

(57) ABSTRACT

An apparatus and method for printing a printing substrate web in a web-fed printing press is disclosed. The web-fed printing press has at least one printing unit for printing at least one, preferably several, printing substrate webs. The web fed-printing press comprises a web guide device, through which the or each printing substrate web can be transported in such a way that, independent of the web guidance of the or each printing substrate web through the web guide device, at least one printing substrate web can be processed on an upper side and/or on a lower side by at least one processing device that is positioned in the region of the web guide device.

This application claims the priority of German Patent Document No. 10 2007 020 736.2, filed May 3, 2007, the disclosure of which is expressly incorporated by reference herein.

### BACKGROUND AND SUMMARY OF THE INVENTION

The invention relates to an apparatus and method for printing a printing substrate web in a web-fed printing press.

Web-fed printing presses have several printing units in order to print at least one printing substrate web, in particular several printing substrate webs, on both sides. The printing units are offset printing units in particular, wherein the or each printing substrate web can be printed conventionally with a static, and therefore the same, print image for all printed copies by means of offset printing units. These types of offset printing units are positioned in a stacked manner in the form of printing towers in the case of web-fed printing presses that are designed as newspaper printing presses. In the case of illustration printing presses, the offset printing units are positioned next to one another.

With web-fed printing presses there is an increasing need to print printing substrate webs not just conventionally using offset printing, but to convey the printing substrate webs for further processing. In this case, we are talking, e.g., about printing-related individualization of printed copies using preferably an inkjet printing device. Further processing, which is possible in addition to offset printing of the printing substrate webs, is, e.g., gluing, coating, drying or even punching. In the case of web-fed printing presses known from practice, processing devices that are used for processing printing substrate webs printed by means of offset printing units are positioned downstream from a folding unit as viewed in the transport direction of the printing substrate webs, i.e., in a location where the production speed is slow.

The advantage of this in principle is that processing or post processing of printing substrate webs printed via offset printing is not coupled to the production speed of the offset printing units. However, a considerable disadvantage is that downstream from a folding unit all printed pages or all locations within a printed copy are not accessible anymore.

Therefore, positioning processing devices downstream from the offset printing units and upstream from the folding unit of the web-fed printing press is already known from practice. However, until now there was no solution that allowed printing substrate webs to flexibly undergo another processing within a web-fed printing press in addition to offset printing.

Starting herefrom, the present invention is based on the objective of creating a novel web-fed printing press. According to the invention, the web-fed printing press is comprised of a web guide device, through which the or each printing substrate web can be transported in such a way that, independent of the web guidance of the or each printing substrate web through the web guide device, at least one printing substrate web can be processed on an upper side and/or on a lower side by means of at least one processing device that is positioned in the region of the web guide device.

The present invention makes it possible for the first time for printing substrate webs that are conventionally printed by means of printing units to flexibly undergo another processing by means of at least one processing unit, and namely in such a way that each printing substrate web can be processed in the region of a processing device in the area of each side, i.e., both in the region of the upper side and the lower side. To do so, the or each processing device cooperates with a web guide device, through which the or each printing substrate web can be transported.

The or each processing device is positioned in the region of the web guide device, wherein the web guide device is integrated into the web-fed printing press at a central location of the web-fed printing press, preferably downstream from the offset printing units as well as upstream from a turning unit.

The web guide device as well as the or each processing device does not have to be remounted within the web-fed printing press during production changes, but the same can remain in the web-fed printing press at the same position as viewed in the transport direction of the printing substrate webs. Processing of the or each printing substrate web is possible at full production speed in addition to conventional offset printing.

Preferred developments of the invention are found in the subsequent description. Without being limited hereto, an exemplary embodiment of the invention is described in greater detail on the basis of the drawings.

### BRIEF DESCRIPTION OF THE DRAWINGS

FIG. 1 is a side view of a schematic representation of a web-fed printing press;

FIG. 2 is a side view of a schematic section of the web-fed printing press in FIG. 1 of Section II in FIG. 1;

FIG. 3 is a side view of the section of FIG. 2 in greater detail;

FIG. 4 is a top view of the section of FIG. 3;

FIG. 5 is a side view of the section of FIG. 3 with a first possible web guidance of printing substrate webs;

FIG. 6 is a side view of the section of FIG. 3 with a second possible web guidance of printing substrate webs;

FIG. 7 is a side view of the section of FIG. 3 with a third possible web guidance of printing substrate webs;

FIG. 8 is a side view of the section of FIG. 3 with a fourth possible web guidance of printing substrate webs;

FIG. 9 is a side view of the section of FIG. 3 with a fifth possible web guidance of printing substrate webs; and

FIG. 10 is a side view of the section of FIG. 3 with a further possible web guidance of printing substrate webs.

### DETAILED DESCRIPTION OF THE DRAWINGS

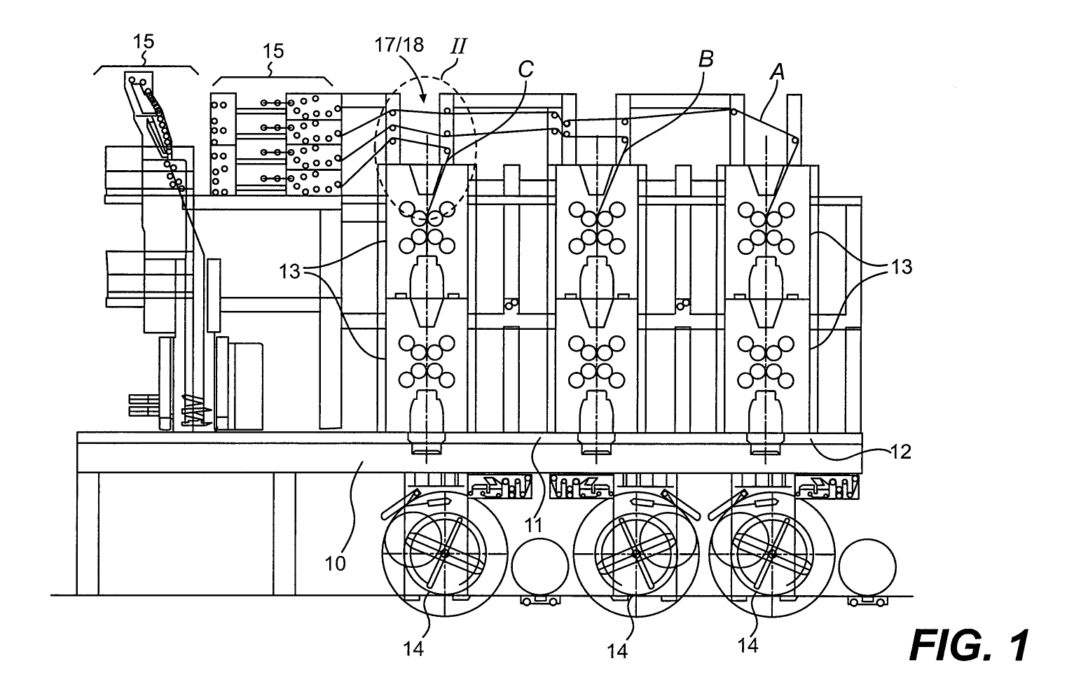

FIG. 1 shows a schematic representation of a web-fed printing press comprising a total of three printing towers 10, 11 and 12. Each printing tower 10, 11 and 12 has two vertically stacked printing units 13 for offset printing, wherein each of these printing units 13 is designed as a H-printing unit having four printing couples. Printing substrate webs, namely printing substrate webs A, B and C in the depicted exemplary embodiment, can be printed on both sides in the region of the printing units 13. The printing substrate webs A, B and C to be printed in the printing towers 10, 11 and 12 are kept in readiness in the region of reel changers 14 and conveyed downstream from the printing towers 10, 11 and 12 via a turning unit 15 to a folding unit 16. Details about reel changers 14, turning units 15 and folding units 16 are familiar to those skilled in the art who are addressed here and they require no further explanation.

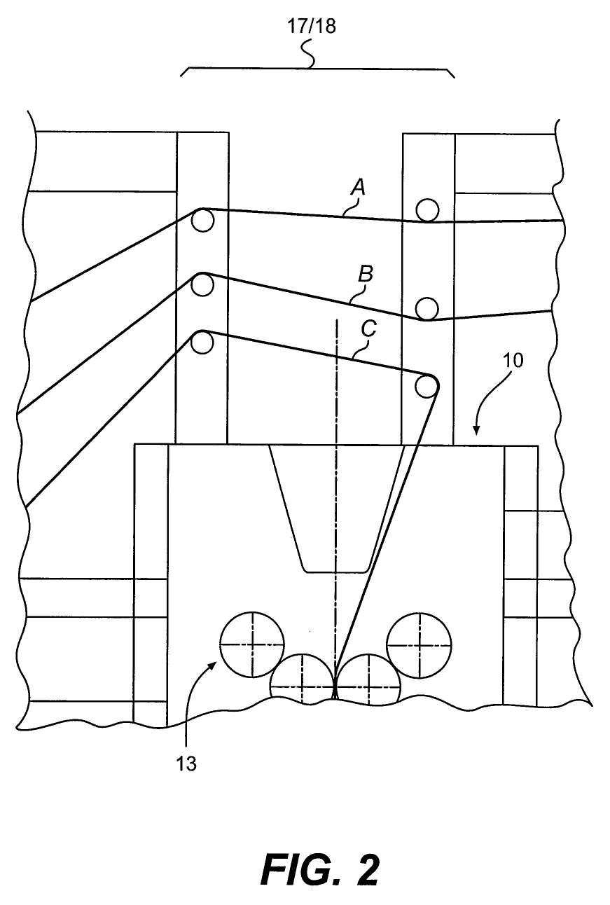

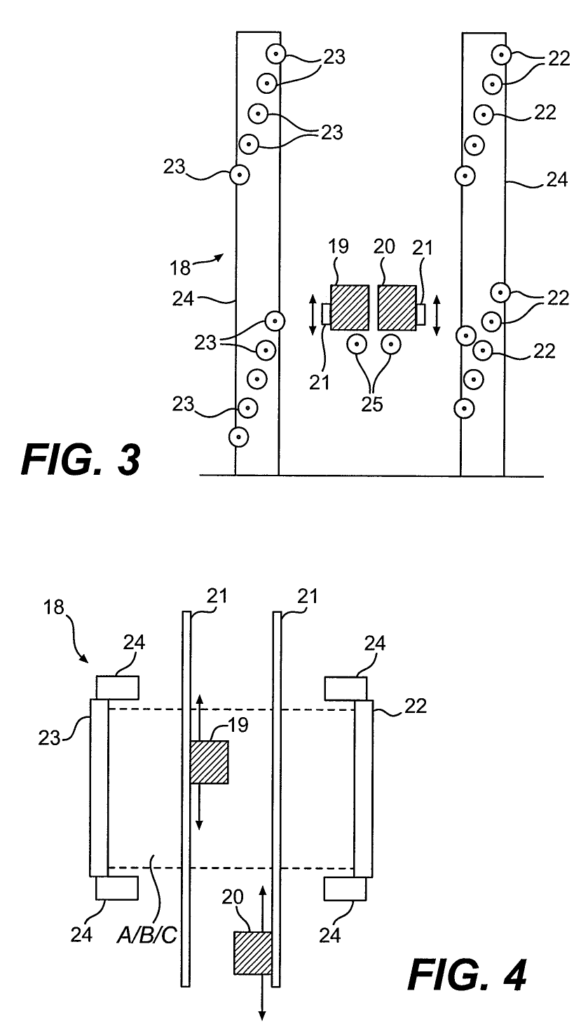

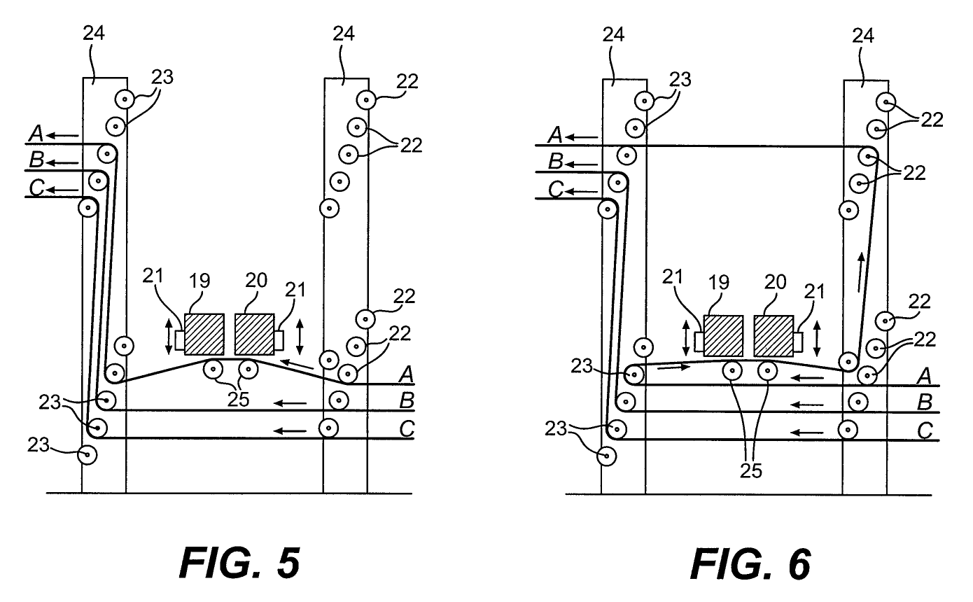

At a defined position 17, namely above the upper printing unit 13 of the printing tower 10 in FIGS. 1 and 2, the printing press 10 is comprised of a web guide device 18, through which all the printing substrate webs A, B and C printed in the printing units 13 can be transported. In FIGS. 1 and 2, the web guide device 18 is depicted only very schematically. FIGS. 3 and 4 show the web guide device in greater detail, however, without the printing substrate webs. FIGS. 5 to 10 show examples of possible web guidance for the printing substrate webs A, B and C through the web guide device 18.

Each of the printing substrate webs A, B and C can be transported by means of the web guide device 18 in such a way that, independent of the web guidance of the printing substrate webs A, B and C through the web guide device 18, at least one of the printing substrate webs A, B and C can be processed on an upper side and/or on a lower side by means of at least one processing device 19 positioned in the region of the web guide device 18.

According to FIGS. 3 to 10, two processing devices 19, 20 are positioned in the region of the web guide device 18. Each of the processing devices 19, 20 is positioned in a translatorily displaceable manner on a traverse 21 in order to thereby move the respective processing device 19, 20 crosswise to the transport direction of the printing substrate webs A, B and C through the web guide device 18 at the position of the respective printing substrate web, at which the processing is supposed to take place.

The processing devices 19, 20 are preferably mounted in a fixed manner on the traverses 21 in the vertical direction, at a height that is appropriate for the respective processing process. The traverses 21 themselves can also be positioned vertically individually in terms of height, if the processing process so requires.

The processing devices 19, 20 can be identical processing devices or even different processing devices. If identical processing devices 19, 20 are being kept in readiness, a redundancy is created in order to process at least one of the printing substrate webs with one of the processing devices 19 or 20, while maintenance work or set-up work is performed on the other processing device 20 or 19. To perform maintenance work or set-up work, the processing devices 19, 20 can be transported crosswise to the transport direction of the printing substrate webs A, B and C in such a way that the devices are displaced laterally next to the printing substrate webs A, B and C.

The processing device 19 and/or the processing device 20 can be embodied preferably as an inkjet printing device, as an adhesive device, as a coating device, as a drying device, as a foil transfer device, as a cutting device, as a perforating device, as a punching device, or as any other type of processing device.

The web guide device 18 of the inventive web-fed printing press has several web guide rollers, namely a first number of input-side web guide rollers 22 and a second number of output-side web guide rollers 23. The web guide rollers 22, 23 are each rotatably mounted on stationary side walls 24 or stationary frame parts. The printing substrate webs A, B and C can be moved into the web guide device 18 via the input-side web guide rollers 22 and, on the other hand, the printing substrate webs A, B and C can be carried away from the web guide device 18 via output-side web guide rollers 23.

The processing devices 19, 20 are positioned in the region of the web guide device 18, and namely between the input-side web guide rollers 22 and the output-side web guide rollers 23 as viewed in the transport direction of the printing substrate webs A, B and C. Additional web guide rollers 25 are positioned along a transport path of the printing substrate webs A, B and C between the input-side web guide rollers 22 and the output-side web guide rollers 23 in the region of the processing devices 19, 20, wherein the web guide rollers 25 guide, and therefore, stabilize the or each to-be-processed printing substrate web A or B or C in the region of the processing devices 19 or 20.

FIGS. 5 to 10 show the possible web guidance for the printing substrate webs A, B and C through the web guide device 18 and therefore along the processing devices 19, 20.

In FIG. 5, the printing substrate webs A, B and C are guided in such a way that the printing substrate web A can be processed in the region of its upper side. In FIG. 6, the web guidance is carried out in such a way that, after turning the printing substrate web A, the printing substrate web can be process in the region of its lower side, wherein the printing substrate web A is subsequently turned again so that the printing substrate webs A, B and C exit the web guide device 18 in the same relative orientation as they entered the web guide device 18.

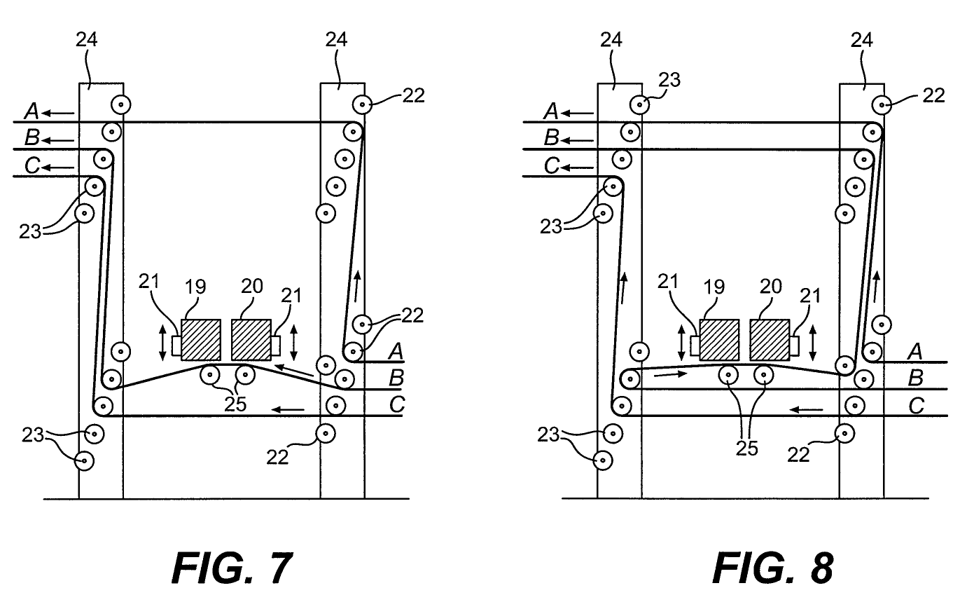

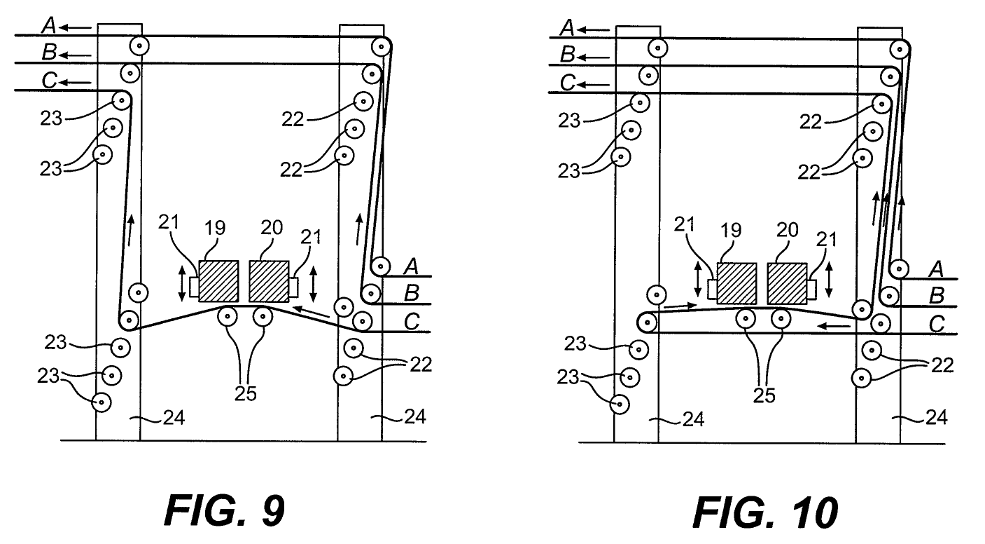

In FIGS. 7 and 8, the printing substrate webs A, B and C are guided in such a way that the printing substrate web B can be processed by means of the processing devices 19, 20, namely in FIG. 7 in the region of an upper side and in FIG. 8 in the region of a lower side of the printing substrate web. FIGS. 9 and 10 show the web guidance of the printing substrate webs A, B and C for processing the printing substrate web C, wherein in FIG. 9 the printing substrate web C can be processed in the region of its upper side and in FIG. 10 in the region of its lower side in the region of the processing devices 19, 20.

The web guide device 18 is preferably assigned an infeed device (not shown), which can be used to define the path of the printing substrate webs through the web guide device 18 in any way during what is commonly known as the infeed process. Such an infeed device can encompass an infeed tip that is used to feed the printing substrate webs along a track system into the web-fed printing press. The printing substrate webs can also be fed into the web guide device without this type of infeed system, namely by hand.

In FIGS. 5 to 10, the printing substrate webs A, B and C are each fed into the web guide device 18 on the lower right and fed out of the same on the upper left, wherein the processing devices 19, 20 for processing the printing substrate webs A, B or C are positioned above the printing substrate webs. At this point, reference is made to the fact that this representation is of a purely exemplary nature.

The printing substrate webs A, B and C can also be fed into the web guide device and fed out of the same at other positions. Furthermore, at least one processing device 19 or 20 can be positioned beneath the to-be-processed printing substrate web. Moreover, it is possible, in contrast to the depicted exemplary embodiments, for the printing substrate webs to be guided not horizontally but in fact vertically in the region of the processing devices, wherein the processing devices are then positioned laterally next to the printing substrate webs.

When using processing devices 19, 20 that are designed as inkjet printing units, however, the embodiment depicted in the Figures, in which the processing devices 19, 20 are positioned above the to-be-processed printing substrate webs A, B or C, is preferred.

The number of web guide rollers depicted in the Figures as well as the number of printing substrate webs depicted is purely exemplary. In addition, the different types of web guidance shown in the Figures are also of a purely exemplary nature.

The web guide device 18 as well as the processing devices 19, 20 are positioned at a fixed position in the web-fed printing press as viewed in the transport direction of the printing substrate webs and namely downstream from the printing towers 10, 11 and 12 as well as upstream from the turning unit 15. Solely due to the type of web guidance of the printing substrate webs through the web guide device 18, the possibility arises for all printing substrate webs to undergo processing both in the region of their upper side as well as in the region of their lower side in the region of the processing devices 19 or 20.

The invention can be used for newspaper printing presses and for illustration printing presses having at least one printing unit.

### LIST OF REFERENCE NUMERALS

10 Printing tower
11 Printing tower
12 Printing tower
13 Printing unit
14 Reel changer
15 Turning unit
16 Folding unit
17 Position
18 Web guide device
19 Processing device
20 Processing device
21 Traverse
22 Web guide roller
23 Web guide roller
24 Side wall
25 Web guide roller

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A web-fed printing press having at least one printing unit for printing a printing substrate web and a web guide device through which the printing substrate web is transportable such that, independent of guidance of the printing substrate web through the web guide device, the printing substrate web is processable on an upper side thereof and/or on a lower side thereof by a processing device that is positioned in a region of the web guide device.

2. The web-fed printing press according to claim 1, wherein the printing units are embodied as offset printing units and form at least one printing tower of a newspaper printing press from several printing units positioned in a stacked manner.

3. The web-fed printing press according to claim 1, wherein the printing units are embodied as offset printing units and form at least one printing path of an illustration printing press from several printing units positioned next to one another.

4. The web-fed printing press according to claim 1, wherein the processing device positioned in the region of the web guide device is embodied as a printing device.

5. The web-fed printing press according to claim 4, wherein the printing device is an inkjet printing device.

6. The web-fed printing press according to claim 1, wherein the processing device positioned in the region of the web guide device is embodied as an adhesive device, or as a coating device, or as a drying device, or as a foil transfer device, or as a cutting device, or as a perforating device, or as a punching device.

7. The web-fed printing press according to claim 1, wherein the web guide device comprises a first number of web guide rollers to convey the printing substrate web to the web guide device and a second number of web guide rollers to carry the printing substrate web away from the web guide device.

8. The web-fed printing press according to claim 7, wherein the processing device is positioned in the region of the web guide device in such a way that the printing substrate web is processable on the upper side and/or on the lower side by the processing device along a transport path between the first number of web guide rollers and the second number of web guide rollers.

9. The web-fed printing press according to claim 8, wherein web guide rollers which are positioned along the transport path between the first number of web guide rollers and the second number of web guide rollers guide and stabilize, in a region of the processing device, the printing substrate web that is processable by the processing device.

10. The web-fed printing press according to claim 1, wherein the processing device is positioned on a traverse and is displaceable along the traverse crosswise to a transport direction of the printing substrate web.

11. The web-fed printing press according to claim 10, wherein the traverse is displaceable vertically in terms of height.

12. The web-fed printing press according to claim 10, wherein the processing device is displaceable on the traverse for a maintenance purpose or a set-up purpose laterally next to the printing substrate web.

13. The web-fed printing press according to claim 1, wherein the web guide device is embodied to be stationary.

14. The web-fed printing press according to claim 1, wherein the web guide device is arranged downstream from the printing units and upstream from a turning unit as viewed in a transport direction of the printing substrate web.

15. The web-fed printing press according to claim 1, wherein a plurality of printing substrate webs are transportable through the web guide device and wherein each of the plurality of printing substrate webs is processable on an upper side thereof and/or on a lower side thereof by the processing device.

16. An apparatus for printing a printing substrate web, comprising:
a printing unit for printing the printing substrate web;
a turning unit disposed downstream from the printing unit in a transport direction of the printing substrate web;
a web guide device, through which the printing substrate web is transportable, disposed between the printing unit and the turning unit; and
a processing device disposed within the web guide device, wherein a non-guidance process is performed on the printing substrate web on an upper side and/or on a lower side of the printing substrate web by the processing device.

17. The apparatus according to claim 16, wherein a second printing unit is vertically stacked with the printing unit in a printing tower.

18. The apparatus according to claim 16, wherein a plurality of printing substrate webs are transportable through the web guide device and wherein each of the plurality of printing substrate webs is processable on an upper side and/or on a lower side of the printing substrate webs by the processing device.

19. A method for printing a printing substrate web, comprising the steps of:
printing the printing substrate web in a printing unit;
transporting the printing substrate web through a web guide device after the step of printing;
performing a non-guidance process on the printing substrate web on an upper side and/or on a lower side of the printing substrate web by a processing device disposed within the web guide device; and
turning the printing substrate web after the step of performing the non-guidance process on the printing substrate web by a turning unit.

20. The method according to claim 19, wherein the non-guidance process performed on the printing substrate web is a second printing step.
